(19) United States
(12) Patent Application Publication
(10) Pub. No.: US 2023/0367643 A1
(43) Pub. Date: Nov. 16, 2023

(54) SYSTEM FOR IDENTIFICATION AND MANAGEMENT OF LAYERED DEPENDENT RESOURCE DISTRIBUTION DEVICES

(71) Applicant: BANK OF AMERICA CORPORATION, Charlotte, NC (US)

(72) Inventors: Steven Michael Twombly, Saco, ME (US); Tony England, Tega Cay, SC (US); Robertson Walters Greenbacker, Charlotte, NC (US); Bradley Ryan Holland, Huntersville, NC (US); Sara A. Walsh, West Chester, PA (US)

(73) Assignee: BANK OF AMERICA CORPORATION, Charlotte, NC (US)

(21) Appl. No.: 17/743,286

(22) Filed: May 12, 2022

(51) Int. Cl. G06F 9/50

(52) U.S. Cl. CPC G06F 9/5061

(57) ABSTRACT

Embodiments of the present invention provide a system for identification and management of layered dependent resource distribution devices. The system is configured for receiving an expunge request from a user to expunge a resource distribution device, via a user interface, determining one or more layered dependent resource distribution devices associated with the resource distribution device, displaying the one or more layered dependent resource distribution devices to the user, via the user interface, receiving a selective expunge request to expunge at least one layered dependent resource distribution device of the one or more layered dependent resource distribution devices, and expunging the resource distribution device associated with the expunge request and the at least one layered dependent resource distribution device of the one or more layered dependent resource distribution devices associated with the selective expunge request.

### BACKGROUND

Conventional systems do not have the capability to identify layered dependent resource distribution devices. As such, there exists a need for a system that identifies and manages layered dependent resource distribution devices.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for identification and management of layered dependent resource distribution devices. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives an expunge request from a user to expunge a resource distribution device, via a user interface, in response to receiving the expunge request, determines one or more layered dependent resource distribution devices associated with the resource distribution device, wherein the one or more layered dependent resource distribution devices comprise at least one or more primary resource distribution devices and one or more secondary resource distribution devices, displays the one or more layered dependent resource distribution devices to the user, via the user interface, in response to displaying the one or more layered dependent resource distribution devices, receives a selective expunge request to expunge at least one layered dependent resource distribution device of the one or more layered dependent resource distribution devices, and expunges the resource distribution device associated with the expunge request and the at least one layered dependent resource distribution device of the one or more layered dependent resource distribution devices associated with the selective expunge request.

In some embodiments, the one or more primary resource distribution devices are created by an entity system and the one or more secondary resource distribution devices are created by one or more third party systems.

In some embodiments, the present invention identifies the entity system based on identifying an enrollment record associated with the resource distribution device in an enrollment database.

In some embodiments, the present invention identifies the one or more third party systems based on identifying one or more historical interactions associated with the resource distribution device.

In some embodiments, the present invention determines the one or more layered dependent resource distribution devices based on establishing a first communication link with the entity system, establishing a second communication link with the one or more third party systems, and querying the entity system via the first communication link and the one or more third party systems via the second communication link to determine the one or more layered dependent resource distribution devices.

In some embodiments, the present invention expunges the resource distribution device and the at least one layered dependent resource distribution device based on transmitting a first set of instructions associated with expunging the resource distribution device to the entity system, via the first communication link, wherein the first set of instructions cause the entity system to expunge the resource distribution device and transmitting a second set of instructions associated with expunging the at least one layered dependent resource distribution device to at least one third party system of the one or more third party systems associated with the at least one layered dependent resource distribution device, via the second communication link, wherein the second set of instructions cause the at least one third party system to expunge the at least one layered dependent resource distribution device.

In some embodiments, the one or more layered dependent resource distribution devices are tokens.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for identification and management of layered dependent resource distribution devices, in accordance with an embodiment of the invention;

FIG. 2 provides a block diagram illustrating the entity system 200 of FIG. 1, in accordance with an embodiment of the invention;

FIG. 3 provides a block diagram illustrating a layered dependent resource distribution device management system 300 of FIG. 1, in accordance with an embodiment of the invention;

FIG. 4 provides a block diagram illustrating the computing device system 400 of FIG. 1, in accordance with an embodiment of the invention; and

FIG. 5 provides a process flow for identification and management of layered dependent resource distribution devices, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “resource entity” or “entity” may be any institution which involves in financial transactions. In some embodiments, the entity may be a financial institution which may include any financial institutions such as commercial banks, thrifts, federal and state savings banks, savings and loan associations, credit unions, investment companies, insurance companies and the like. As described herein, a “user” may be a customer or a potential customer of the entity. In some embodiments, a “user” may be a financial institution customer (e.g., an account holder or a person who has an account (e.g., banking account, credit account, or the like)). An “account” or “resource pool” may be the relationship that the customer has with the financial institution. Examples of accounts include a deposit account, such as a transactional account (e.g. a banking account), a savings account, an investment account, a money market account, a time deposit, a demand deposit, a pre-paid account, a credit account, a non-monetary customer information that includes only personal information associated with the customer, or the like. The account is associated with and/or maintained by a financial institution.

As used here, the term “third party entity” may refer to any merchant associated with providing products, goods, services, and/or the like to the users (e.g., customers) of the entity. A “resource instrument” or a “resource distribution device” as used herein may be any instrument used by the users to perform interactions or resource distribution requests. Examples of resource instruments may include, but are not limited to, a credit card, a debit card, or the like. As used herein, the term “interaction” or “resource distribution request” may refer to transactions performed by users of the entity using one or more resource distribution device towards purchase of products, goods, services, and/or the like.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access, develop, manage, maintain, test, and/or use one or more applications provided by the entity and/or the system of the present invention. In some embodiments, the user may be an employee of the entity. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, when a user enrolls a resource distribution device with a digital wallet provider, a primary layered dependent resource distribution device (also referred to as primary token(s)) may be created by the digital wallet provider based on the resource distribution device, where the primary token may act as a substitute to the resource distribution device when a user performs an interaction using the resource distribution device, via digital wallet. Additionally, when a user performs an interaction with a third party entity, via the resource distribution device and/or the primary token (via the digital wallet), third party system associated with the third party entity may create a secondary layered dependent resource distribution device (also referred to as secondary token(s)) and store the secondary token in a data repository. When a user requests to delete a resource distribution device from a digital wallet, only the resource distribution device will be deleted leaving the primary tokens and secondary tokens created in the background. As such, there is no way for the user to know about the primary tokens and secondary tokens that are linked to the resource distribution device, thereby increasing the exposure associated with the resource distribution device. Therefore, there exists a need for system that can effectively monitor, track, and identify one or more tokens linked with the resource distribution device and allow the user to manage the one or more tokens. The system of the present invention provides a technical solution to these technical problems as discussed in detail below.

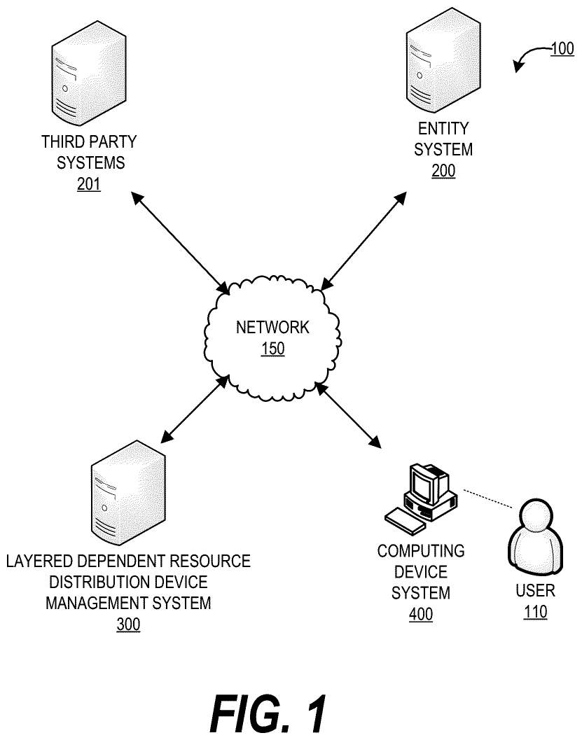

FIG. 1 provides a block diagram illustrating a system environment 100 for identification and management of layered dependent resource distribution devices, in accordance with an embodiment of the invention. As illustrated in FIG. 1, the environment 100 includes a layered dependent resource distribution device management system 300, an entity system 200, a computing device system 400, and one or more third party systems 201. One or more users 110 may be included in the system environment 100, where the users 110 interact with the other entities of the system environment 100 via a user interface of the computing device system 400. In some embodiments, the one or more user(s) 110 of the system environment 100 may be customers or potential customers of an entity associated with the entity system 200.

The entity system(s) 200 may be any system owned or otherwise controlled by an entity to support or perform one or more process steps described herein. In some embodiments, the entity may be any organization that involves in financial transaction. In some embodiments, the entity is a financial institution. In some embodiments, the entity system may also act as a digital wallet provider. In some embodiments, the one or more third party systems 201 may be any merchants that provide products, goods, services, and/or the like to the users of the entity.

The layered dependent resource distribution device management system 300 is a system of the present invention for performing one or more process steps described herein. In some embodiments, the layered dependent resource distribution device management system 300 may be an independent system. In some embodiments, the layered dependent resource distribution device management system 300 may be a part of the entity system 200.

The layered dependent resource distribution device management system 300, the entity system 200, the computing device system 400, and the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the layered dependent resource distribution device management system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the layered dependent resource distribution device management system 300, and/or entity system 200 across the network 150.

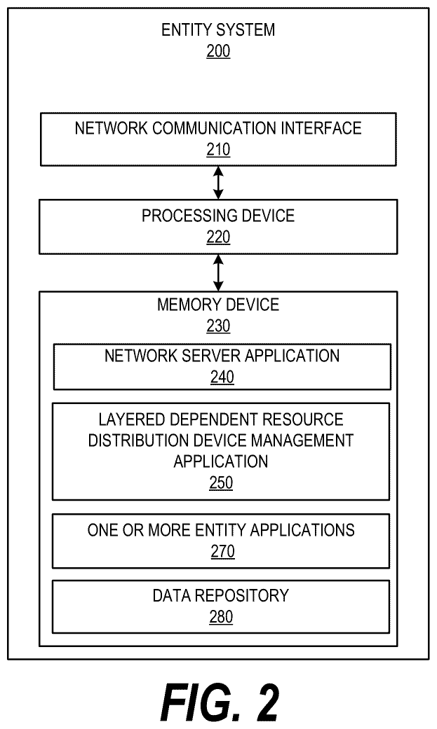

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a layered dependent resource distribution device management application 250, one or more entity applications 270, and a data repository 280 comprising historical transaction data associated with one or more resource pools of users 110. The one or more entity applications 270 may be any applications developed, supported, maintained, utilized, and/or controlled by the entity that perform one or more organizational activities. In one embodiments, the entity application may be an online banking application. The computer-executable program code of the network server application 240, the layered dependent resource distribution device management application 250, the one or more entity application 270 to perform certain logic, data-extraction, and data-storing functions of the entity system 200 described herein, as well as communication functions of the entity system 200.

The network server application 240, the layered dependent resource distribution device management application 250, and the one or more entity applications 270 are configured to store data in the data repository 280 or to use the data stored in the data repository 280 when communicating through the network communication interface 210 with the layered dependent resource distribution device management system 300, and/or the computing device system 400 to perform one or more process steps described herein. In some embodiments, the entity system 200 may receive instructions from the layered dependent resource distribution device management system 300 via the layered dependent resource distribution device management application 250 to perform certain operations. The layered dependent resource distribution device management application 250 may be provided by the layered dependent resource distribution device management system 300.

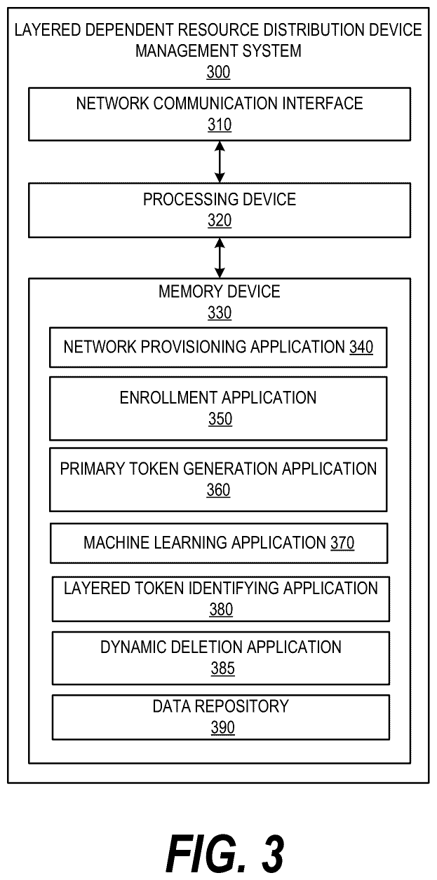

FIG. 3 provides a block diagram illustrating the layered dependent resource distribution device management system 300 in greater detail, in accordance with embodiments of the invention. As illustrated in FIG. 3, in one embodiment of the invention, the layered dependent resource distribution device management system 300 includes one or more processing devices 320 operatively coupled to a network communication interface 310 and a memory device 330. In certain embodiments, the layered dependent resource distribution device management system 300 is operated by an entity, such as a financial institution. In some embodiments, the layered dependent resource distribution device management system 300 is owned or operated by the entity of the entity system 200. In some embodiments, the layered dependent resource distribution device management system 300 may be an independent system. In alternate embodiments, the layered dependent resource distribution device management system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the layered dependent resource distribution device management system 300 described herein. For example, in one embodiment of the layered dependent resource distribution device management system 300, the memory device 330 includes, but is not limited to, a network provisioning application 340, an enrollment application 350, a primary token generation application 360, a machine learning application 370, a layered token identifying application 380, a dynamic deletion application 385, and a data repository 390 comprising any data processed or accessed by one or more applications in the memory device 330. The computer-executable program code of the network provisioning application 340, the enrollment application 350, the primary token generation application 360, the machine learning application 370, the layered token identifying application 380, and the dynamic deletion application 385 may instruct the processing device 320 to perform certain logic, data-processing, and data-storing functions of the layered dependent resource distribution device management system 300 described herein, as well as communication functions of the layered dependent resource distribution device management system 300.

The network provisioning application 340, the enrollment application 350, the primary token generation application 360, the machine learning application 370, the layered token identifying application 380, and the dynamic deletion application 385 are configured to invoke or use the data in the data repository 390 when communicating through the network communication interface 310 with the entity system 200, and/or the computing device system 400. In some embodiments, the network provisioning application 340, the enrollment application 350, the primary token generation application 360, the machine learning application 370, the layered token identifying application 380, and the dynamic deletion application 385 may store the data extracted or received from the entity system 200, and the computing device system 400 in the data repository 390. In some embodiments, the network provisioning application 340, the enrollment application 350, the primary token generation application 360, the machine learning application 370, the layered token identifying application 380, and the dynamic deletion application 385 may be a part of a single application.

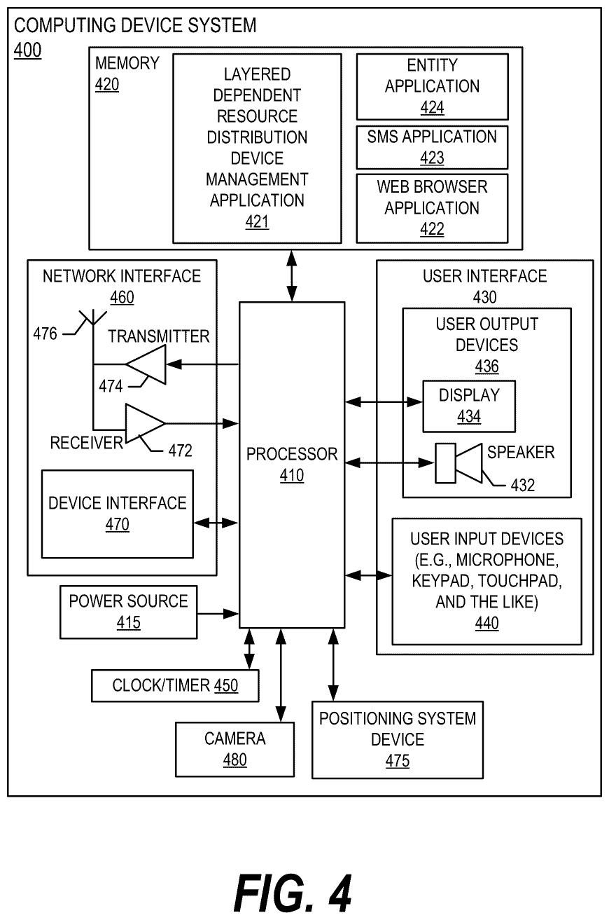

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a layered dependent resource distribution device management application 421, and an entity application 424. These applications also typically instructions to a graphical user interface (GUI) on the display 430 that allows the user 110 to interact with the entity system 200, the layered dependent resource distribution device management system 300, and/or other devices or systems. The memory 420 of the computing device system 400 may comprise a Short Message Service (SMS) application 423 configured to send, receive, and store data, information, communications, alerts, and the like via the wireless network 152. In some embodiments, the entity application 424 may be an online banking application. In some embodiments, the layered dependent resource distribution device management application 421 provided by the layered dependent resource distribution device management system 300 allows the user 110 to access the layered dependent resource distribution device management system 300. In some embodiments, the entity application 424 provided by the entity system 200 and the layered dependent resource distribution device management application 421 allow the user 110 to access the functionalities provided by the layered dependent resource distribution device management system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

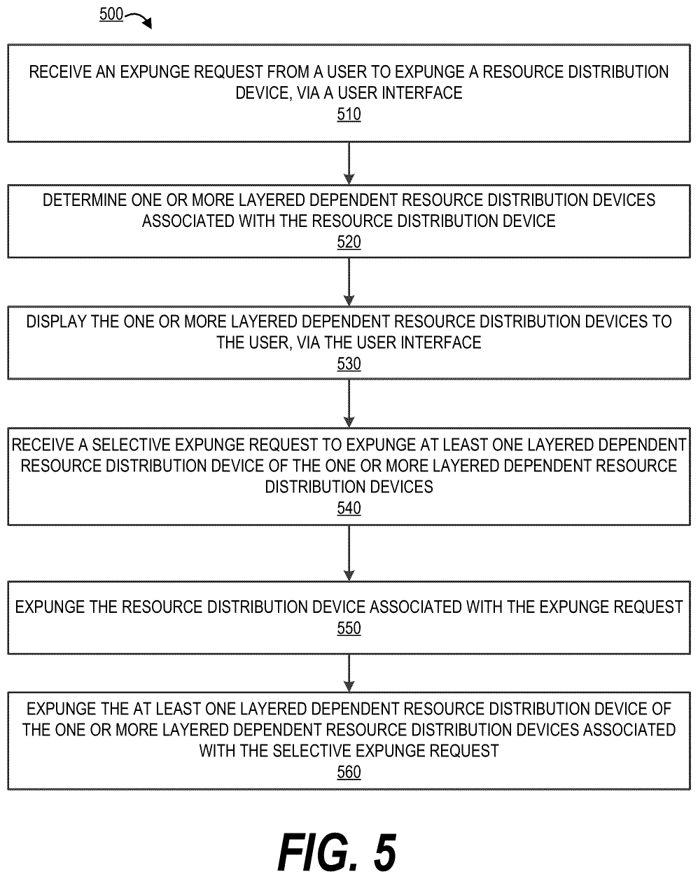

FIG. 5 provides a process flow for identification and management of layered dependent resource distribution devices, in accordance with an embodiment of the invention. As shown in block 510, the system receives an expunge request from a user to expunge a resource distribution device, via a user interface. In some embodiments, the expunge request may be associated with deleting the resource distribution device from a digital wallet. For example, the user may submit a request to delete a first credit card from a digital wallet. In some embodiments, the expunge request may be associated with deleting the resource distribution device from one or more data repositories. In some embodiments, the one or more data repositories may be associated with an entity system and/or one or more third party entities.

As shown in block 520, the system determines one or more layered dependent resource distribution devices associated with the resource distribution device. In some embodiments, the one or more layered dependent resource distribution devices may be tokens. In response to receiving the expunge request, the system may identify the one or more layered dependent resource distribution devices which may comprise one or more primary layered dependent resource distribution devices and one or more secondary layered dependent resource distribution devices.

In some embodiments, the one or more primary layered dependent resource distribution devices may be created by an entity system associated with an entity (e.g., digital wallet provider). In some embodiments, the primary layered dependent resource distribution device may be created based on the resource distribution device. For example, the entity system may create a primary token using information associated with the credit card (e.g., credit card number, expiration data, or the like). In such embodiments, the user may submit an enrollment request to the entity system. the entity system may receive the enrollment request associated with the resource distribution device from the user, perform enrollment of the resource distribution device based on receiving the enrollment request, generate an enrollment record associated with the enrollment of the resource distribution device, and store the enrollment record in the enrollment database. In some embodiments, the system of the present invention may act as the digital wallet provider.

In some embodiments, the one or more secondary layered dependent resource distribution devices may be created by one or more third party system associated with one or more third party entities (e.g., merchants). For example, when a user performs a transaction at a merchant via a digital wallet using a primary token (i.e., substitute to the credit card), the merchant may create a secondary token associated with the credit card and the digital wallet. In some embodiments, the secondary token created by the merchant may be based on the primary token. In some embodiments, the primary token and/or the secondary token are linked to the resource distribution device.

In some embodiments, the system may identify the primary token and/or the entity system associated with the primary token based on the enrollment record stored in the enrollment database. In some embodiments, the system may identify the one or more one or more third party systems based on identifying one or more historical interactions associated with the resource distribution device. In some embodiments, the system may determine the one or more layered dependent resource distribution devices based on establishing a first communication link with the entity system, establishing a second communication link with the one or more third party systems, and querying the entity system via the first communication link and the one or more third party systems via the second communication link to determine the one or more layered dependent resource distribution devices.

As shown in block 530, the system displays the one or more layered dependent resource distribution devices to the user, via the user interface. As shown in block 540, the system receives a selective expunge request to expunge at least one layered dependent resource distribution device of the one or more layered dependent resource distribution devices. For example, the user may select to delete a secondary token ‘A’ associated with merchant ‘A’ and secondary token ‘B’ associated with merchant ‘B’ while leaving all other secondary tokens identified by the system. In some embodiments, the process flow, instead of beginning at block 510, may be initiated by the user by submitting a request, via the user interface, to view the one or more tokens associated with the resource distribution device and then selecting at least one token of the one or more tokens for deletion.

As shown in block 550, the system expunges the resource distribution device associated with the expunge request. In some embodiments, the system may expunge the resource distribution device based on transmitting a first set of instructions associated with expunging the resource distribution device to the entity system, via the first communication link, wherein the first set of instructions cause the entity system to expunge the resource distribution device.

As shown in block 560, the system expunges the at least one layered dependent resource distribution device of the one or more layered dependent resource distribution devices associated with the selective expunge request. In some embodiments, the system may expunge the at least one layered dependent distribution device based on transmitting a second set of instructions associated with expunging the at least one layered dependent resource distribution device to at least one third party system of the one or more third party systems associated with the at least one layered dependent resource distribution device, via the second communication link, wherein the second set of instructions cause the at least one third party system to expunge the at least one layered dependent resource distribution device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| Docket Number | application Ser. No. | Title | Filed On |
| 13266US1.014033.4328 | To be assigned | ELECTRONIC SYSTEM FOR | Concurrently |
| | | DYNAMIC LINKING OF RESOURCE | herewith |
| | | DATA STRUCTURES ACROSS | |
| | | DISTRIBUTED NETWORKS | |

1. A system for identification and management of layered dependent resource distribution devices, the system comprising:
at least one network communication interface;
at least one non-transitory storage device; and
at least one processing device coupled to the at least one non-transitory storage device and the at least one network communication interface, wherein the at least one processing device is configured to:
receive an expunge request from a user to expunge a resource distribution device, via a user interface;
in response to receiving the expunge request, determine one or more layered dependent resource distribution devices associated with the resource distribution device, wherein the one or more layered dependent resource distribution devices comprise at least one or more primary resource distribution devices and one or more secondary resource distribution devices;
display the one or more layered dependent resource distribution devices to the user, via the user interface;
in response to displaying the one or more layered dependent resource distribution devices, receive a selective expunge request to expunge at least one layered dependent resource distribution device of the one or more layered dependent resource distribution devices; and
expunge the resource distribution device associated with the expunge request and the at least one layered dependent resource distribution device of the one or more layered dependent resource distribution devices associated with the selective expunge request.

2. The system of claim 1, wherein the one or more primary resource distribution devices are created by an entity system and the one or more secondary resource distribution devices are created by one or more third party systems.

3. The system of claim 2, wherein the at least one processing device is configured to identify the entity system based on identifying an enrollment record associated with the resource distribution device in an enrollment database.

4. The system of claim 2, wherein the at least one processing device is configured to identify the one or more third party systems based on identifying one or more historical interactions associated with the resource distribution device.

5. The system of claim 2, wherein the at least one processing device is further configured to determine the one or more layered dependent resource distribution devices based on:
establishing a first communication link with the entity system;
establishing a second communication link with the one or more third party systems; and
querying the entity system via the first communication link and the one or more third party systems via the second communication link to determine the one or more layered dependent resource distribution devices.

6. The system of claim 5, wherein the at least one processing device is further configured to expunge the resource distribution device and the at least one layered dependent resource distribution device based on:
transmitting a first set of instructions associated with expunging the resource distribution device to the entity system, via the first communication link, wherein the first set of instructions cause the entity system to expunge the resource distribution device; and
transmitting a second set of instructions associated with expunging the at least one layered dependent resource distribution device to at least one third party system of the one or more third party systems associated with the at least one layered dependent resource distribution device, via the second communication link, wherein the second set of instructions cause the at least one third party system to expunge the at least one layered dependent resource distribution device.

7. The system of claim 1, wherein the one or more layered dependent resource distribution devices are tokens.

8. A computer program product for identification and management of layered dependent resource distribution devices, the computer program product comprising a non-transitory computer-readable storage medium having computer executable instructions for causing a computer processor to perform the steps of:
receiving an expunge request from a user to expunge a resource distribution device, via a user interface;
in response to receiving the expunge request, determining one or more layered dependent resource distribution devices associated with the resource distribution device, wherein the one or more layered dependent resource distribution devices comprise at least one or more primary resource distribution devices and one or more secondary resource distribution devices;
displaying the one or more layered dependent resource distribution devices to the user, via the user interface;
in response to displaying the one or more layered dependent resource distribution devices, receiving a selective expunge request to expunge at least one layered dependent resource distribution device of the one or more layered dependent resource distribution devices; and
expunging the resource distribution device associated with the expunge request and the at least one layered dependent resource distribution device of the one or more layered dependent resource distribution devices associated with the selective expunge request.

9. The computer program product of claim 8, wherein the one or more primary resource distribution devices are created by an entity system and the one or more secondary resource distribution devices are created by one or more third party systems.

10. The computer program product of claim 9, wherein the computer executable instructions cause the computer processor to perform the step of identifying the entity system based on identifying an enrollment record associated with the resource distribution device in an enrollment database.

11. The computer program product of claim 9, wherein the computer executable instructions cause the computer processor to perform the step of identifying the one or more third party systems based on identifying one or more historical interactions associated with the resource distribution device.

12. The computer program product of claim 9, wherein the computer executable instructions cause the computer processor to perform the step of determining the one or more layered dependent resource distribution devices based on:
establishing a first communication link with the entity system;
establishing a second communication link with the one or more third party systems; and
querying the entity system via the first communication link and the one or more third party systems via the second communication link to determine the one or more layered dependent resource distribution devices.

13. The computer program product of claim 12, wherein the computer executable instructions cause the computer processor to perform the step of expunging the resource distribution device and the at least one layered dependent resource distribution device based on:
transmitting a first set of instructions associated with expunging the resource distribution device to the entity system, via the first communication link, wherein the first set of instructions cause the entity system to expunge the resource distribution device; and
transmitting a second set of instructions associated with expunging the at least one layered dependent resource distribution device to at least one third party system of the one or more third party systems associated with the at least one layered dependent resource distribution device, via the second communication link, wherein the second set of instructions cause the at least one third party system to expunge the at least one layered dependent resource distribution device.

14. The computer program product of claim 8, wherein the one or more layered dependent resource distribution devices are tokens.

15. A computer implemented method for identification and management of layered dependent resource distribution devices, wherein the method comprises:
receiving an expunge request from a user to expunge a resource distribution device, via a user interface;
in response to receiving the expunge request, determining one or more layered dependent resource distribution devices associated with the resource distribution device, wherein the one or more layered dependent resource distribution devices comprise at least one or more primary resource distribution devices and one or more secondary resource distribution devices;
displaying the one or more layered dependent resource distribution devices to the user, via the user interface;
in response to displaying the one or more layered dependent resource distribution devices, receiving a selective expunge request to expunge at least one layered dependent resource distribution device of the one or more layered dependent resource distribution devices; and
expunging the resource distribution device associated with the expunge request and the at least one layered dependent resource distribution device of the one or more layered dependent resource distribution devices associated with the selective expunge request.

16. The computer implemented method of claim 15, wherein the one or more primary resource distribution devices are created by an entity system and the one or more secondary resource distribution devices are created by one or more third party systems.

17. The computer implemented method of claim 16, wherein the method further comprises identifying the entity system based on identifying an enrollment record associated with the resource distribution device in an enrollment database.

18. The computer implemented method of claim 15, wherein the method further comprises identifying the one or more third party systems based on identifying one or more historical interactions associated with the resource distribution device.

19. The computer implemented method of claim 15, wherein determining the one or more layered dependent resource distribution devices comprises:
establishing a first communication link with the entity system;
establishing a second communication link with the one or more third party systems; and
querying the entity system via the first communication link and the one or more third party systems via the second communication link to determine the one or more layered dependent resource distribution devices.

20. The computer implemented method of claim 15, wherein expunging the resource distribution device and the at least one layered dependent resource distribution device comprises:
transmitting a first set of instructions associated with expunging the resource distribution device to the entity system, via the first communication link, wherein the first set of instructions cause the entity system to expunge the resource distribution device; and
transmitting a second set of instructions associated with expunging the at least one layered dependent resource distribution device to at least one third party system of the one or more third party systems associated with the at least one layered dependent resource distribution device, via the second communication link, wherein the second set of instructions cause the at least one third party system to expunge the at least one layered dependent resource distribution device.
